(19) United States
(12) Patent Application Publication
(10) Pub. No.: US 2002/0142794 A1
(43) Pub. Date: Oct. 3, 2002

(54) Portable wireless terminal

(75) Inventor: Nobuya Harano, Shizuoka (JP)

Correspondence Address: Paul J. Esatto, Jr., Scully, Scott, Murphy & Presser, 400 Garden City Plaza, Garden City, NY, 11530, US

(73) Assignee: NEC Corporation, Tokyo (JP)

(21) Appl. No.: 10/103,339

(22) Filed: Mar. 21, 2002

(30) Foreign Application Priority Data
Mar. 28, 2001 (JP) 92440/2001

(51) Int. Cl. H04B 1/38

(52) U.S. Cl. 455/550; 455/575; 455/90

(57) ABSTRACT

A portable wireless terminal according to the present invention includes an external antenna provided outside a housing and an internal antenna having a rectangular solid-shape formed inside the housing into a rectangular solid shape. The internal antenna having a rectangular solid-shape is not affected by influences of human bodies such as the human head and the human hand, and is disposed in the vicinity of a microphone unit and is attached to a back surface of a front panel of the housing.

### BACKGROUND OF THE INVENTION

1. Field of the Invention

The present invention relates to a portable wireless terminal that has an antenna device capable of suppressing degradation of transmitted or received radio waves, which is induced by influence of a user's hand or head.

2. Description of the Related Art

With the current development of mobile communication, a portable wireless terminal is rapidly becoming common. When a call is made with the portable wireless terminal, the portable wireless terminal is usually held by human hand unless an earphone or the like is used. In the portable wireless terminal, its antenna is required a reduced size in order to maintain portability thereof. Accordingly, the antenna is brought into contact with the user's hand, head, and ear when the user holds the portable wireless terminal, which becomes a serious cause of degradation of antenna characteristics. Further, it is becoming increasingly common to build the antenna therein for achieving the miniaturization. However, in such a structure, when the portable wireless terminal is held by the human hand, the human hand or head comes close to the antenna and its vicinity, thereby becoming a serious cause of degradation of antenna characteristics.

### SUMMARY OF THE INVENTION

The present invention has been made in view of the above, and an object of the present invention is therefore to provide a portable wireless terminal capable of suppressing degradation of transmitted or received radio waves, which is induced by influences of the user's hand and head, to thereby maintain call characteristic in a more stable manner.

To attain the above object, the present invention is provided with: a housing; an internal antenna which is equipped inside the housing; a device substrate fixed to the inner portion of the housing, on which a circuit for realizing desired functions is mounted; and a microphone which is attached to the device substrate, in which the internal antenna is disposed at a position on the back surface of the front panel of the housing and in the vicinity of the microphone.

Further, according to the present invention, as the internal antenna, an internal antenna having a rectangular solid-shape in which a conductor is provided in a spiral form within a base body that is constituted as a dielectric having a rectangular solid-shape.

Further, according to the present invention, a linear-type internal antenna which is processed into a desired configuration using a linear-type conductor maybe also employed as the internal antenna.

Further, according to the present invention, a plate-type internal antenna which is processed into a desired configuration using a plate-type conductor may be employed as the internal antenna as well.

Yet still further, according to the present invention, a circuit-patterned internal antenna formed by printing a conductor on a surface of the device substrate is preferably employed as the internal antenna.

Also, according to the present invention, in a portable wireless terminal provided with: an upper housing; a lower housing attached so as to be freely opened and closed with respect to the upper housing; an internal antenna equipped inside the lower housing; a device substrate fixed to the inner portion of the lower housing, on which a circuit for realizing desired functions is mounted; and a microphone which is attached to the device substrate, the internal antenna is disposed at a position on the back surface of the front panel of the lower housing and in the vicinity of the microphone.

Further, the portable wireless terminal according to the present invention is characterized in that the portable wireless terminal comprises: a housing; an external antenna attached outside the housing; a device substrate fixed to the inner portion of the housing, on which a circuit for realizing desired functions is mounted; and a microphone which is provided on the device substrate, and that the microphone functions as a part of the antenna in itself.

### BRIEF DESCRIPTION OF THE DRAWINGS

The above and other objects, features and advantages of the present invention will become more apparent from the following detailed description when taken in conjunction with the accompanying drawing wherein

FIG. 1 is a view showing a structure of a portable wireless terminal according to Embodiments 1 to 7;

FIG. 2 is a view showing a structure of an internal antenna and a device substrate of the portable wireless terminal according to Embodiment 1;

FIG. 3 is a view showing a structure of a linear-type internal antenna and a device substrate of the portable wireless terminal according to Embodiment 2;

FIG. 4 is a view showing a structure of a plate-type internal antenna and a device substrate of the portable wireless terminal according to Embodiment 3;

FIG. 5 is a view showing a structure of a circuit-patterned internal antenna and a device substrate of the portable wireless terminal according to Embodiment 4;

FIG. 6 is a view showing a structure of an internal antenna and a device substrate of the portable wireless terminal according to Embodiment 5;

FIG. 7 is a view showing a structure of an internal antenna and a device substrate of the portable wireless terminal according to Embodiment 6;

FIG. 8 is a view showing a structure of the portable wireless terminal according to Embodiment 7.

### DETAILED DESCRIPTION OF THE PREFERRED EMBODIMENTS

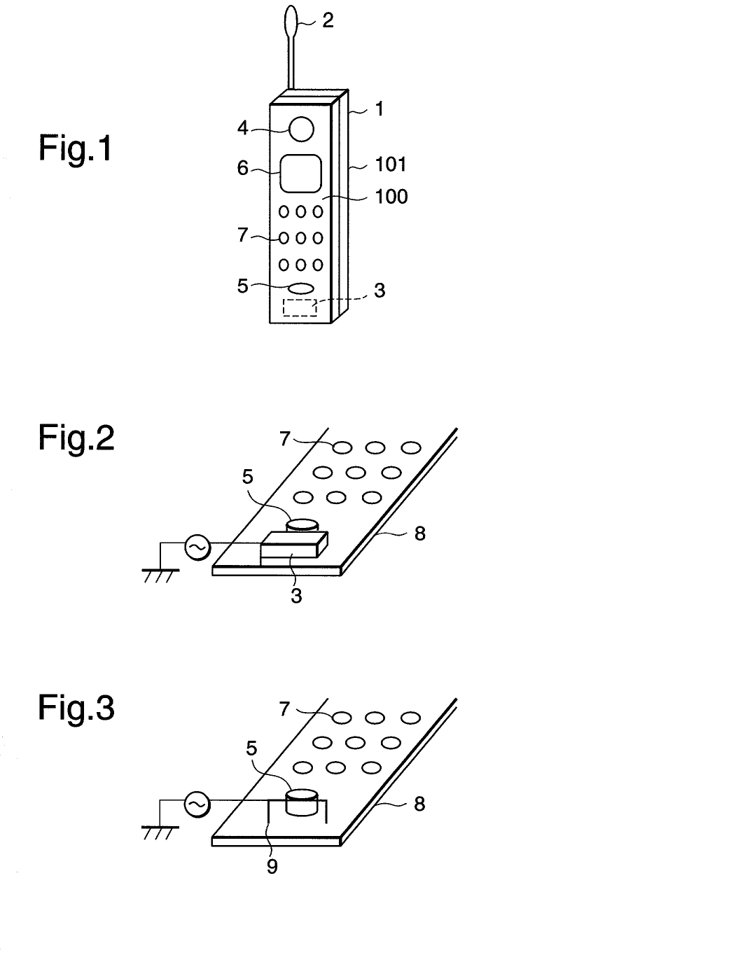

First, Embodiment 1 of the present invention will be described with reference to FIGS. 1 and 2. FIG. 1 is a perspective view showing a portable wireless terminal provided with an antenna device according to Embodiment 1. FIG. 2 is a perspective view showing a structure of the antenna device and a device substrate that are employed for the portable wireless terminal illustrated in FIG. 1.

In FIG. 1, a receiver unit (call reception unit) 4 and a microphone unit (call transmission unit) 5 are disposed on a front surface of a housing 1 of the portable wireless terminal. The housing 1 includes a front surface panel 100 and a back surface panel 101. Also, the portable wireless terminal includes a display unit 6 that conducts liquid-crystal display and a key unit 7 which is composed of a ten-key, function keys, and so on and the above units are provided on the front surface of the housing 1. Further, the portable wireless terminal includes a wireless circuit and a control circuit for controlling the entire terminal (both are not shown) and the above circuits are mounted on the device substrate which will be described below.

An external antenna 2 is attached so as to be projected from the upper portion of the housing 1. An internal antenna unit 3 having a rectangular solid-shape includes a base body constituted as a dielectric having a rectangular solid-shape and an antenna unit in which a conductor is wound in a spiral form within the base body. The internal antenna unit 3 having a rectangular solid-shape is disposed below the vicinity of the microphone unit 5 and is attached to the back surface of the front surface 100 of the housing 1. In accordance with the condition of transmitted or received radio waves, switching between the external antenna 2 and the internal antenna unit 3 having a rectangular solid-shape is effected to use the one having better transmission/reception condition.

In FIG. 2, a device substrate 8 provided inside the housing 1 is fixed to the housing 1, on which the microphone unit 5, the key unit 7 and required circuits such as a transmission, reception circuit are mounted. The internal antenna unit 3 having a rectangular solid-shape is connected with the device substrate 8 through a lead wire.

As described above, according to the above embodiment, the external antenna 2 is attached so as to be projected from the upper portion of the housing 1. Also, the internal antenna unit 3 having a rectangular solid-shape is disposed at the lower portion of the housing 1. Therefore it is possible to prevent the portable wireless terminal from being simultaneously affected by the user's hand and head, thereby attaining improved characteristics of transmitted or received radio waves. Also, since the internal antenna unit 3 having a rectangular solid-shape is attached to the front surface side of the housing 1, it is not easily affected by a palm in which the housing 1 is held. From a consideration that a user may think that a calling is disabled if the microphone unit 5 is covered with his or her fingers during a call, the internal antenna unit 3 having a rectangular solid-shape is arranged below the vicinity of the microphone unit 5, to thereby reduce the influence of fingers of the human hand. Note that, even when the internal antenna unit 3 having a rectangular solid-shape is arranged above the vicinity of the microphone unit 5, the same effect is obtained.

Next, Embodiment 2 will be described with reference to FIGS. 1 and 3.

In Embodiment 2, the internal antenna unit 3 having a rectangular solid-shape illustrated in FIG. 1 is replaced by a linear-type internal antenna unit 9, in which a terminal end of the linear-type antenna is folded so as to be perpendicular with respect to a (lengthwise) direction of the device substrate to be connected with the device substrate and in which a forward end thereof is folded in a (lengthwise) direction of the device substrate so as not to come into contact with the device substrate. The linear-type internal antenna 9 is disposed below the microphone unit 5 and is attached to the device substrate 8.

Thus, according to the above Embodiment 2, the same effect as that in Embodiment 1 is obtained.

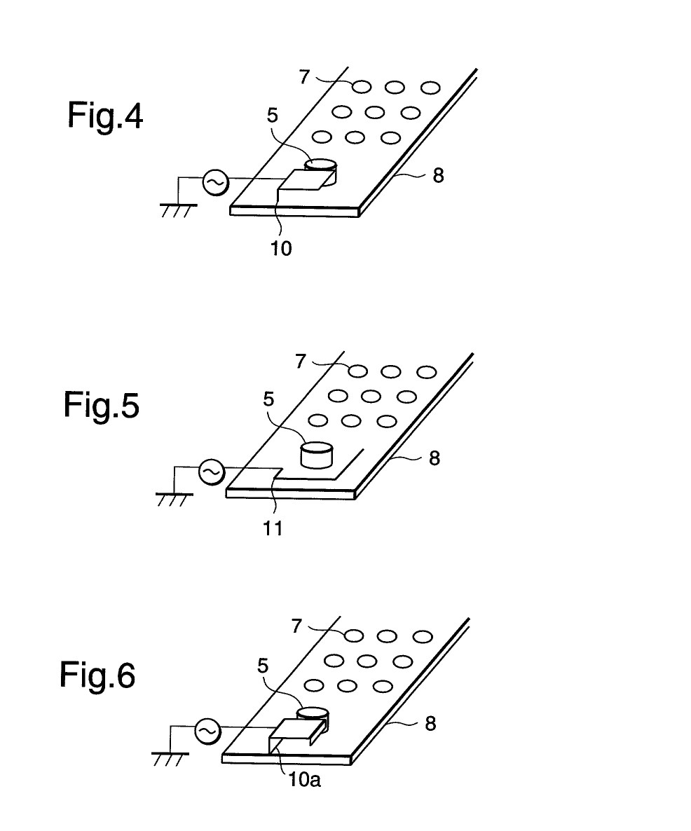

Next, Embodiment 3 will be described with reference to FIGS. 1 and 4.

In the embodiment, the internal antenna unit 3 having a rectangular solid-shape illustrated in FIG. 1 is replaced by a plate-type internal antenna unit 10. FIG. 4 is a view showing a structure of a device substrate 8 with which the plate-type internal antenna unit 10 is connected.

In FIG. 4, the plate-type internal antenna unit 10 is an antenna that has a planar form, which is attached to the back surface of the front surface panel of a housing 1 and is provided below the vicinity of the microphone unit 5. The plate-type internal antenna unit 10 is connected with the device substrate 8 through a lead wire.

Thus, in a similar manner to the above-described Embodiment 2, the above Embodiment 3 is capable of reducing degradation of transmitted or received radio waves, which is caused due to the influences of the user's head and hand. When compared with the above-described Embodiment 2, the plate-type internal antenna unit 10 allows an effective area of the antenna to become larger, thereby improving the characteristics of the antenna as a single unit.

Next, Embodiment 4 will be described with reference to FIGS. 1 and 5.

In Embodiment 4, the internal antenna unit 3 having a rectangular solid-shape illustrated in FIG. 1 is replaced by a circuit-patterned internal antenna unit 11. FIG. 5 is a view showing a structure of a device substrate 8 which is provided with the circuit-patterned internal antenna unit according to the present embodiment. In FIG. 5, the circuit-patterned internal antenna unit 11 is formed on the upper surface of the device substrate by being printed thereon. The circuit-patterned internal antenna unit 11 is formed around the microphone unit 5 such that the respective sides thereof are arranged orthogonal to each other.

Thus, in a similar manner to the above-described Embodiment 1, the above Embodiment 4 is capable of reducing degradation of transmitted or received radio waves, caused due to influences of the user's head and hand. The circuit-patterned internal antenna unit 11 has no limitation with respect to a direction of the height, with the result that the efficiency of mounting is also improved.

Next, Embodiment 5 will be described with reference to FIGS. 1 and 6.

In Embodiment 5, the internal antenna unit 3 having a rectangular solid-shape illustrated in FIG. 1 is replaced by a plate-type internal antenna unit 10a. In the plate-type internal antenna unit 10a, both a forward end side thereof and a terminal end side thereof are folded at right angles. The terminal end side is attached to a device substrate 8.

Thus, according to the above Embodiment 5, the same effect as that in Embodiment 1 is obtained.

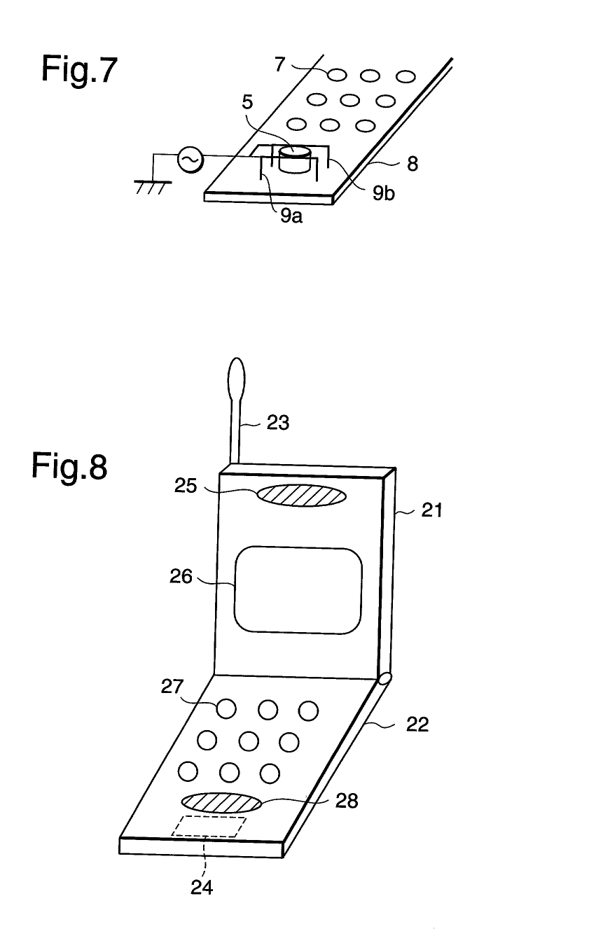

Next, Embodiment 6 will be described with reference to FIGS. 1 and 7. In Embodiment 6, the internal antenna unit 3 having a rectangular solid-shape illustrated in FIG. 1 is replaced by a linear-type internal antenna unit 9a in which a terminal end thereof is folded so as to be perpendicular with respect to a lengthwise direction of the device substrate 8 to thereby be connected with the device substrate 8 and in which a forward end thereof is folded in a direction perpendicular to a direction of the device substrate 8 so as not to come into contact with the device substrate 8. A linear-type internal antenna unit 9b has a formation similar to that of the above-described linear-type internal antenna unit 9a. The linear-type internal antenna unit 9a is disposed below the microphone unit 5, whereas the linear-type internal antenna unit 9b is disposed above the microphone unit 5. Even when either the linear-type internal antenna unit 9a or the linear-type internal antenna unit 9b suffers from degradation of radio wave characteristics, switching is effected to use the other linear-type internal antenna that is not suffering from such degradation, so that transmission, reception processing may be conducted by the other antenna. Thus, according to the above Embodiment 6, the same effect as that in Embodiment 1 is obtained.

Next, Embodiment 7 will be described with reference to FIG. 8. Fig.8 is a view showing a structure of a portable wireless terminal which includes a lower housing that can be freely opened and closed. An upper housing 21 is provided with an external antenna 23, a receiver unit 25 and a display unit 26. A key unit 27 and a microphone unit 28 are mounted on a lower housing 22 that can be freely opened and closed, which is attached to the upper housing 21. An internal antenna unit 24 is located on the back surface side of the front panel of the lower housing 22 and is provided in the vicinity of the microphone unit 28 so as to be adjacent thereto.

According to the above embodiment, it is possible to suppress degradation of transmitted or received radio waves, which is caused by influences of human bodies, and also to attach the internal antenna on the lower housing which can be freely opened and closed.

In the above Embodiments 1 to 7, an internal antenna is used as a separate unit. However, when a casing accommodating the microphone unit 5 itself is made of metal, the casing that accommodates the microphone unit 5 can function as a part of the internal antenna, thereby making it possible to suppress degradation of transmitted or received radio waves, which is caused by influence of human bodies, and to improve the efficiency of mounting. Note that, the casing accommodating the microphone unit 5 is electrically connected with the internal antenna.

As described above, according to the present invention, an internal antenna which is provided in the vicinity of a microphone unit and is attached to the back surface of a front panel of a housing, thereby attaining an effect of suppressing degradation of transmitted or received radio waves, which is caused by influence of the user's head or hand.

Further, the same effect can be obtained, and also in a portable wireless terminal provided with an upper housing to which a lower housing that can be freely opened and closed is attached.

Also, the microphone unit itself, which is attached to the housing functions as a part of the antenna. Therefore, there are obtained effects such that degradation of transmitted or received radio waves, which is caused by influence of human bodies, can be suppressed and the efficiency of mounting can be improved.

While this invention has been described in connection with certain preferred embodiments, it is to be understood that the subject matter encompassed by way of this invention is not to be limited to those specific embodiments. On the contrary, it is intended for the subject matter of the invention to include all alternative, modification and equivalents as can be included within the spirit and scope of the following claims.

What is claimed is:

1. A portable wireless terminal, comprising:
a housing;
an internal antenna equipped inside the housing;
a device substrate fixed to the inner portion of the housing, on which a circuit for realizing desired functions is mounted; and
a microphone attached to the device substrate,
wherein the internal antenna is disposed on the back surface of the front panel of the housing and in the vicinity of the microphone.

2. A portable wireless terminal according to claim 1, wherein an internal antenna having a rectangular solid-shape, in which a conductor is provided in a spiral from within a base body constituted as a dielectric having a rectangular solid-shape, is employed as the internal antenna.

3. A portable wireless terminal according to claim 1, wherein a linear-type internal antenna, which is processed into a desired configuration using a linear-type conductor, is employed as the internal antenna.

4. A portable wireless terminal according to claim 1, wherein a plate-type internal antenna, which is processed into a desired configuration using a plate-type conductor, is employed as the internal antenna.

5. A portable wireless terminal according to claim 1, wherein a circuit-patterned internal antenna formed by printing a conductor on a surface of the device substrate is employed as the internal antenna.

6. A portable wireless terminal, comprising:
an upper housing;
a lower housing attached so as to be freely opened and closed with respect to the upper housing;
an internal antenna equipped inside the lower housing;
a device substrate fixed to the inner portion of the lower housing, on which a circuit for realizing desired functions is mounted; and
a microphone attached to the device substrate,
wherein the internal antenna is disposed on the back surface of the front panel of the lower housing and in the vicinity of the microphone.

7. A portable wireless terminal, comprising:
a housing;
a device substrate fixed to the inner portion of the housing, on which a circuit for realizing desired functions is mounted; and
a microphone provided to the device substrate,
wherein the microphone functions as a part of the antenna in itself.
